(19) United States
(12) Patent Application Publication
(10) Pub. No.: US 2026/0301321 A1
(43) Pub. Date: Oct. 1, 2026

(54) INTERACTIVE SUPPORT SYSTEM USING MACHINE LEARNING-BASED MOTION TRANSCRIPTION AND CAPTIONING

(71) Applicant: MICROSOFT TECHNOLOGY LICENSING, LLC, Redmond, WA (US)

(72) Inventors: Andréa BRITTO MATTOS LIMA, Sao Paulo (BR); Spencer G. FOWERS, Duvall, WA (US); Thiago VALLIN SPINA, Campinas (BR); Deepti Balachandra HEGDE, Baltimore, MD (US)

(21) Appl. No.: 19/093,198

(22) Filed: Mar. 27, 2025

(51) Int. Cl. G06T 17/20; G06T 13/40

(52) U.S. Cl. CPC G06T 17/20; G06T 13/40

(57) ABSTRACT

Disclosed are techniques for transcribing motions of a subject participating in a 3D videoconference. In some configurations, a caption describing the subject’s motion is overlaid proximal to the 3D representation of the subject. Additionally, or alternatively, physical metrics of the subject may be computed and displayed in real-time. In some configurations, a 4D mesh of the subject is analyzed to make a per-frame determination of the subject’s pose. Joint coordinates may be obtained from the poses and transformed into text-based representations. The per-frame text-based representations of the joint coordinates may then be provided with a prompt context to a machine learning model to infer a description of the motion and/or physical metrics of the subject.

### BACKGROUND

Traditional telemedicine systems rely on 2D video conferencing. However, these systems lack the spatial depth and immersive presence required for effective communication in complex medical scenarios. One technology that addresses some of these weaknesses is real-time volumetric capture technology, such as Microsoft's Holoportation™, which provides a dynamic 3D representation of the patient's movements over time to a remote viewer. However, even a high-resolution 3D representation of the patient may not reveal enough information to make a correct diagnosis.

It is with respect to these and other considerations that the disclosure made herein is presented.

### SUMMARY

Disclosed are techniques for transcribing motions of a subject participating in a 3D videoconference. In some configurations, a caption describing the subject’s motion is overlaid proximal to the 3D representation of the subject. This provides additional information to a remote viewer of the subject, such as a category of motion or an indication of changes in a range of motion over time. Additionally, or alternatively, physical metrics of the subject may be computed and displayed in real-time, such as speed of motion and motion smoothness. The displayed information may have many uses, such as diagnosing a medical condition, evaluating recovery from injury, evaluating the skill of an athlete, etc.

In some configurations, a 4D mesh of the subject is analyzed to make a per-frame determination of the subject’s pose. Joint coordinates may be obtained from the poses and transformed into text-based representations. The per-frame text-based representations of the joint coordinates may then be provided with a prompt context to a machine learning model to infer a description of the motion.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates generating 3D representations of a subject.

FIG. 2 illustrates using a parameterized model of a subject to generate a text-based representation of joints of the subject.

FIG. 4 is a flow diagram of an example method for an interactive support system using machine learning-based motion transcription and captioning.

FIG. 5 is a computer architecture diagram illustrating an illustrative computer hardware and software architecture for a computing system capable of implementing aspects of the techniques and technologies presented herein.

### DETAILED DESCRIPTION

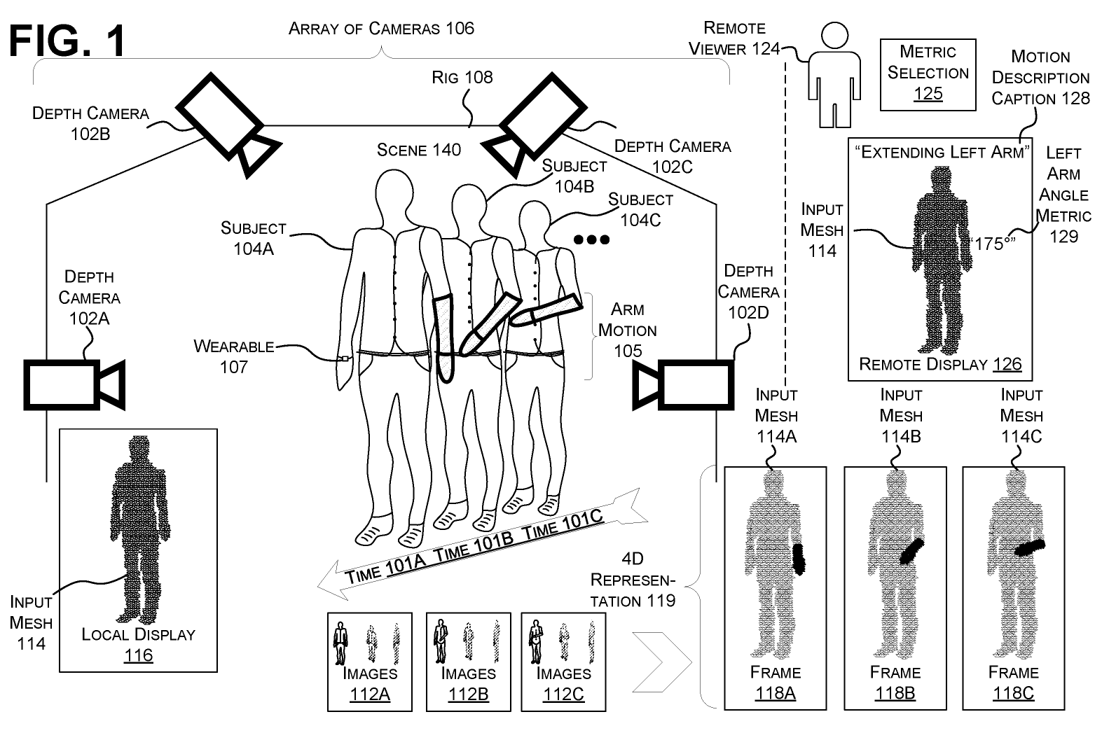

FIG. 1 illustrates generating 3D representations of a subject. Multiple depth cameras 102 capture sets of images 112 of subject 104. Depth cameras 102 may be attached to rig 108, which holds depth cameras 102 in place so as to view scene 140 from different perspectives.

Depth cameras 102, which are collectively referred to as array of cameras 106, may capture color images of scene 140 as well as depth maps that precisely measure a distance for each pixel. For example, depth camera 102A may include a synchronized RGB camera for capturing color and a depth camera for capturing depth. Additionally, or alternatively depth cameras 102 may not include a dedicated depth sensor. For these cameras, depth information may be inferred from the red, green, and blue values of the RGB camera. Depth information allows for the creation of 3D representations of scene 140 or objects within it.

Depth cameras 102 use various technologies to capture depth information, including: Time-of-Flight (ToF), Structured Light, and Stereo Vision. Time of Flight cameras emit light or infrared signals and measure the time it takes for the signal to bounce back to the camera. By calculating the time delay, the camera can determine the distance between the camera and objects in the scene. Structured light cameras project a pattern of light onto the scene and analyze the distortion of the pattern as it interacts with objects. This distortion is used to calculate depth information based on the known pattern. Stereo cameras use two or more camera lenses to capture the same scene from slightly different angles. By comparing the disparities between the images, the depth information can be computed using triangulation techniques.

Depth cameras 102 are used to capture a set of images 112 of subject 104 from different perspectives at the same time or approximately the same time. As time 101 passes, depth cameras 102 may capture multiple sets of images 112, such as set of images 112A of subject 104A at time 101A, set of images 112B of subject 104B at time 101B, and set of images 112C of subject 1014C at time 101C. Specifically, at time 101C, which is furthest in the past, subject 104C has their left arm bent. This is reflected by set of images 112C. At time 101B subject 104B has extended their left arm partially. At time 101A subject 104A has completely or almost completely extended their left arm.

Depth camera image data of images 112 is used to generate input mesh 114. Input mesh 114 is a 3-dimensional (3D) representation of subject 104. Input mesh 114 is depicted with triangles, but any polygon, combination of polygons, splines, or other mathematical descriptions may similarly be used to describe the contour of subject 104. Input mesh 114 may be generated in real-time as subject 104 moves about scene 140.

A collection of 3D representations of subject 104 can be thought of as a four-dimensional (4D) representation 119 of subject 104. As illustrated, input mesh 114A is generated from images 112A, and as such includes the most recent depiction of subject 104. Input mesh 114A may be stored within frame 118A of 4D representation 119 of subject 104. Similarly, input mesh 114B is derived from set of images 112B and is stored in frame 118B of 4D representation 119. Input mesh 114C is derived from set of images 112C and is stored in frame 118C of 4D representation 119.

In some scenarios, subject 104 is a medical patient and input mesh 114 is generated as part of a telemedicine application. Input mesh 114 may be displayed for a medical practitioner or other remote viewer 124 sitting remotely from subject 104, such as a physiotherapist or doctor. For example, a medical practitioner may view input mesh 114 on remote display 126 while remotely diagnosing, advising, or otherwise interacting with subject 104. Input mesh 114 may also be displayed locally on local display 116, enabling subject 104 to observe some or all of what remote viewer 124 is able to observe. The disclosed embodiments may also be used for non-medical purposes, such as to evaluate the skills and abilities of athletes.

In some configurations, 4D representation 119 is analyzed to determine motion description caption 128. Motion description caption 128 is a text-based description of motion observed in subject 104. As illustrated, subject 104 has extended their left arm, and so motion description caption 128 is “extending left arm”.

Motion description caption 128 may be displayed in various locations relative to input mesh 114. For instance, motion description caption 128 may be overlaid on the same display that renders input mesh 114, such as remote display 126 or local display 116. Motion description caption 128 may also be displayed on a separate display device positioned nearby. Motion description caption 128 may be positioned above, below, or to the side of input mesh 114 to avoid obscuring, or to minimize or only partially obscure, the visual representation of subject 104. Additionally, motion description caption 128 may be located proximate to the specific portion of subject 104 that is being moved, such as near the left arm if the arm is in motion. Visual cues may complement the caption, such as highlighting the moving body part or displaying a trail indicating the path taken by the moving portion over time, providing a clear visual history of movement.

Motion description caption 128 may correspond to the entire body of subject 104 or to a particular portion of subject 104, such as an individual limb or joint. The portion to which motion description caption 128 applies may be selected manually by remote viewer 124. For instance, remote viewer 124 may wish to focus on a specific body part relevant to a particular medical assessment. Alternatively, the portion may be selected automatically based on contextual information, such as a known injury or treatment area, or based on the reason subject 104 is being observed, such as post-surgical recovery monitoring, athletic performance evaluation, etc.

4D representation 119 may also be analyzed to determine one or more metrics describing characteristics of subject 104. These metrics may include quantitative information about the size, length, orientation, position, and angles of different portions of subject 104. Some metrics may be computed using data from a single frame 118. For example, left arm angle metric 129 may measure the angle of the left arm in frame 118A. Other single-frame metrics might include bone lengths, and limb orientations. In addition, metrics may be computed across multiple frames, such as the smoothness of a motion, the total range of motion over time, maximum and minimum joint angles, and/or acceleration and deceleration patterns of specific movements.

Remote viewer 124 may choose which metrics are computed based on the task at hand. A metric selection 125 interface may be provided, allowing remote viewer 124 to explicitly select desired metrics, such as "left arm angle," "range of motion," or "joint smoothness." Additionally, metric selection 125 may support predefined collections of metrics relevant to particular use cases. For example, a predefined set of metrics may be provided for monitoring recovery after elbow surgery, encompassing measurements like elbow joint angles, extension range, and motion smoothness. Remote viewer 124 may switch between different collections of metrics depending on the evaluation context.

In some configurations, the system may automatically determine which metrics to compute based on the properties of subject 104. These properties may be input manually by remote viewer 124 or another person, such as demographic data or medical history. Alternatively, properties may be inferred through analysis of input mesh 114 or 4D representation 119, such as detecting the presence of a limb cast or abnormal gait. Based on these properties, the system may prioritize or adjust which metrics are computed, tailoring the analysis to the specific needs of subject 104. A similar analysis may be used to automatically select which portions of subject 104 to have their motion described.

In some configuration, the same metric may be captured over time. This series of metrics may be compared to identify patterns and changes in subject 104. For example, subject 104 may be assessed both before and after undergoing surgery on their left elbow. In this scenario, metrics such as range of motion, maximum extension, and joint smoothness for the left arm may be measured pre-surgery and post-surgery. The system may automatically compute the difference in these metrics to highlight improvements or regressions in recovery. The results of these comparisons may be visualized alongside input mesh 114 by themselves. Additionally, or alternatively, the results of these comparisons may be integrated within specific metrics like left arm angle metric 129, providing clear, quantifiable evidence of progress over time.

In the medical context, metrics may assist remote viewer 124 in diagnosing conditions, monitoring recovery, facilitating rehab, and tailoring individualized treatment plans. In a sports context, metrics may indicate the speed of a bat swung by a baseball player, the height of a jump of a basketball player, or the smoothness of a slapshot of a hockey player.

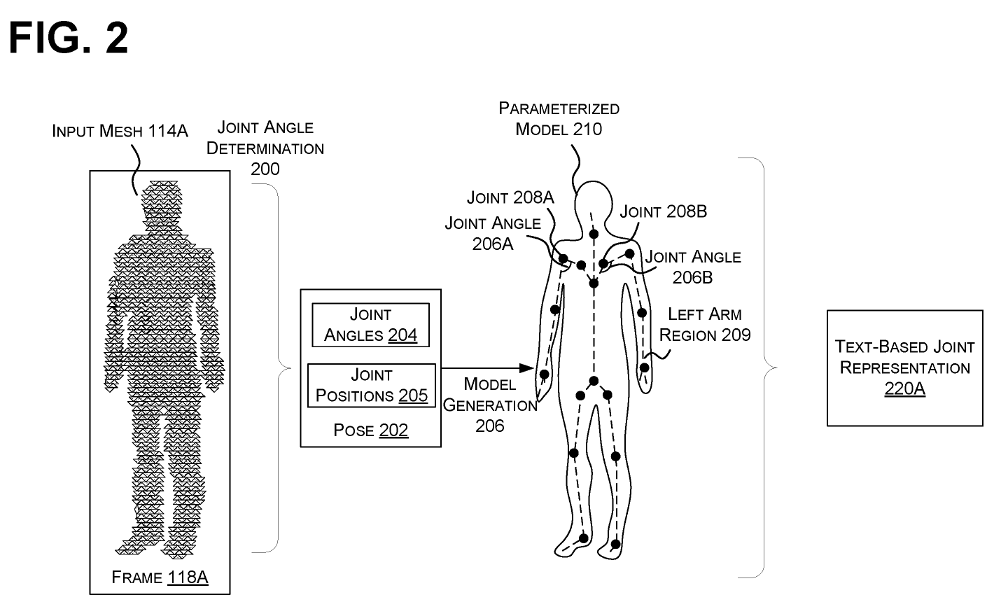

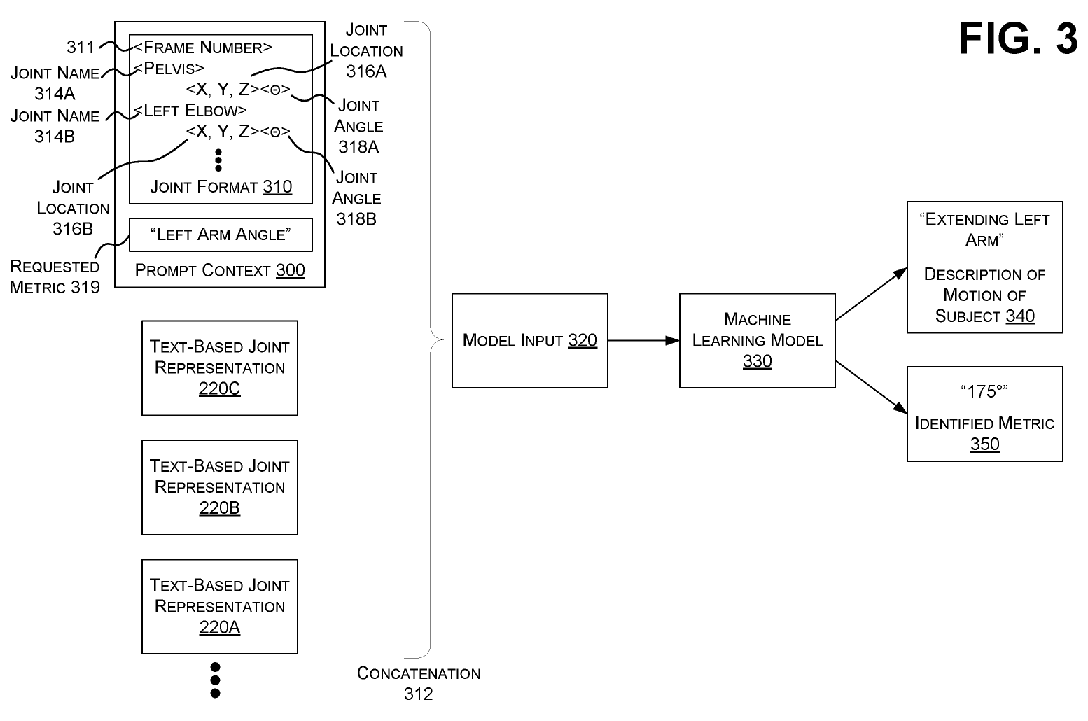

FIG. 2 illustrates using a parameterized model of a subject to generate a text-based representation of joints of the subject. Input mesh 114A is depicted as one example of generating text-based joint representation 220A. This process may be performed in real-time or near real-time on other frames 118 of 4D representation 119.

In some configurations, joint angle determination 200 is performed on input mesh 114A to determine pose 202. Specifically, joint angle determination 200 identifies joint angles 204 and/or joint positions 205 of pose 202. Joint angle determination 200 may be performed by motion tracking software such as FRANK MOCAP.

Model generation 206 provides pose 202 to parameterized model 210. In some configurations, joint angles 204 and/or joint positions 205 are the parameters of parameterized model 210. Parameterized model 210, such as a Skinned Multi-Person Linear (SMPL) model, provides a realistic, controllable, and compact way to generate and manipulate human body meshes.

As illustrated, parameterized model 210 includes one or more locations of joints 206. In some configurations, joint angles 206 of joints 208 are computed by or otherwise represented in parameterized model 210. Joint angle 206A may be computed from the location of joint 208A and the locations of the adjacent joints. For example, joint angle 206A may be computed by taking the arccosine of the normalized dot product of the vectors from joint 208A to the adjacent joints. Parameterized model 210 my represent subject 104 with 24 different joints, such as pelvis, spine1, spine2, chest, neck, head, and right and left foot, ankle, knee, hip, collar, shoulder, elbow, wrist, and hand.

Parameterized model 210 may be used to generate text-based joint representation 220A. Text-based joint representation 220A encodes joint positions, and/or orientations and angles, in a structured format. Different markup languages may be used to represent joint information in text-based joint representation 220A, such as JavaScript Object Notation (JSON), eXtensible Markup Language (XML), etc. Text-based joint representation may be generated for multiple frames 118 of 4D representation 119.

Parameterized model 210 may also break subject 104 into multiple regions. For example, left arm region 209 illustrates one region of subject 104. Regions may be used to limit how much data is analyzed when determining motion and metrics of subject 104. For example, regions of subject 104 may be analyzed to exclude data from regions that are unrelated to a target region.

FIG. 3 illustrates using a number of text-based joint representations to infer a motion of the subject. Text-based joint representations 220A, 220B, and 220C represent the joint information extracted from input meshes 114A, 114B, and 114C, respectively. Prompt context 300 is a set of plain-text instructions, examples, and other information used by machine learning model 330 to process text-based joint representations 220. FIG. 3 illustrates three text-based joint representations, but this is just for illustrative purposes - any number of text-based joint representations are similarly contemplated. Machine learning model 330 may be a generative model, such as a multi-modal model, a large language model, or a machine learning model that has been specifically trained to identify motion and metrics from a series of text-based joint representations 220.

Concatenation 312 combines prompt context 300 with text-based joint representations 220A, 220B, and 220C into model input 320. Typically, prompt context 300 is prepended to text-based joint representations 220, which are ordered from furthest in the past to most recent. As illustrated, model input 320 would begin with prompt context 300 and be followed by text-based joint representation 220C, which represents the pose subject 104 furthest in the past, followed by text-based joint representations 220B and 220A. However, other orderings are similarly contemplated.

In order to increase the length of time over which motion and metrics are identified without overburdening the resources of the computing device powering machine learning model 330, text-based joint representations may be selectively omitted from model input 320. For example, every other text-based joint representation 220 may be excluded from model input 320.

Prompt context 300 may include joint format 310, a definition of the structure of joint information encoded in text-based joint representations 220. For example, joint format 310 may include frame number 311, indicating how text-based joint representations 220 indicate which frame 118 they represent. Frame number 311 may indicate that text-based joint representations 220 use a serial number, a timestamp, or other ordinal or cardinal number to indicate a point in time or a location in an ordering.

Joint format 310 may also include, for example, an indication of how joints are structured in text-based joint representations 220. As illustrated, joint name 314A, pelvis, indicates that the nested joint location 316A and optional joint angle 318A are for the pelvis of subject 104. Similarly, joint name 314B, left elbow, indicates that the following joint location 316B and joint angle 318B are for the left elbow. Joint locations may be defined numerically in 3D Cartesian or polar coordinates. Joint angles 318 may be indicated in degrees, radians, or the like.

In some configurations, prompt context 300 may include instructions to identify particular motions or types of motions. For example, prompt context 300 may include an instruction to categorize the motion expressed by the different text-based joint representations 220. These instructions may tell machine learning model 330 to describe the motion of subject 104 in terms of simple, plausible human motion, such as extending an arm or bending at the waist. Additionally, or alternatively, prompt context 300 may instruct machine learning model 330 to identify more complex, domain specific types of motion, such as motions that are indicative of particular diseases or other conditions.

Based on these instructions, machine learning model 330 may infer one or more descriptions of motion of subject 340. As discussed above in conjunction with FIG. 1, descriptions of motion of subject 340 may be displayed as text overlaid in real-time with a display of input mesh 114A on one or more displays 126 and 116. This is illustrated in FIG. 1 as motion description caption 128.

In some configurations, prompt context 300 includes requested metric 319. Requested metric 319 includes one or more metrics to be inferred by machine learning model 330, such as motion smoothness, joint angle, or other metrics described herein. Requested metric 319 may reflect metric selection 125 made by remote viewer 124, although requested metric 319 may also be selected automatically in response to an analysis of motion of subject 104. As illustrated, requested metric 319 is “Left Arm Angle”. As a result, machine learning model 330 generates identified metric 350, “175°”.

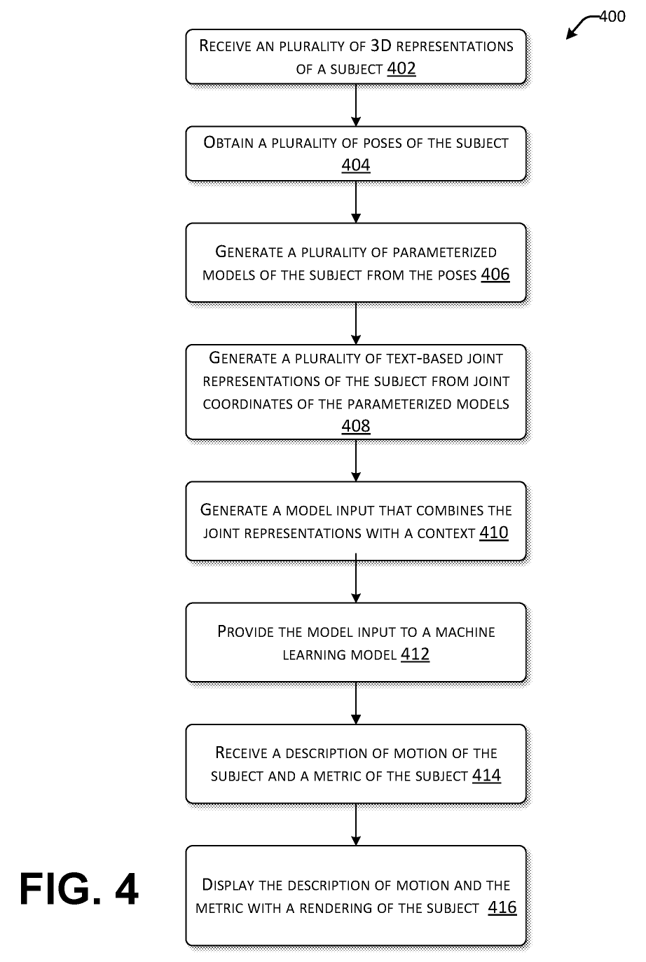

With reference to FIG. 4, routine 400 begins at operation 402, where a plurality of 3D representations 114 of subject 104 are received. 3D representations 114 may be received from depth cameras 102 or inferred from image data captured by depth cameras 102.

Next at operation 404, a plurality of poses 202 are obtained of subject 104. Poses 202 are obtained from 3D representations 114 taken at different points of time 101.

Next at operation 406, a plurality of parameterized models 210 are generated from the poses 202. Parameterized models 210 may be parameterized by joint angles 204 and/or joint positions 205 computed by joint angle determination 200, which analyzes input meshes 114.

Next at operation 408, a plurality of text-based joint representations 220 of subject 104 are generated from joint coordinates 208 of parameterized models 210. These joint coordinates 208 are obtained from the locations of regions of parameterized models 210, and may be different from joint positions 205.

Next at operation 410, model input 320 is generated from prompt context 300 and one or more text-based joint representations 220.

Next at operation 412, model input 320 is provided to machine learning model 330. Machine learning model may be a general purpose large language model, specially trained to identify motion from a series of text-based joint representations 220, or other type of machine learning model.

Next at operation 414, a description of motion 340 of subject 104 and a metric 350 of subject 104 is received from machine learning model 330.

Next at operation 416, the description of motion 340 and/or the metric 350 are displayed proximate to a rendering of the subject 104.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 400 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 400 may be also implemented in many other ways. For example, the routine 400 may be implemented, at least in part, by a processor of another remote computer or a local circuit. In addition, one or more of the operations of the routine 400 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

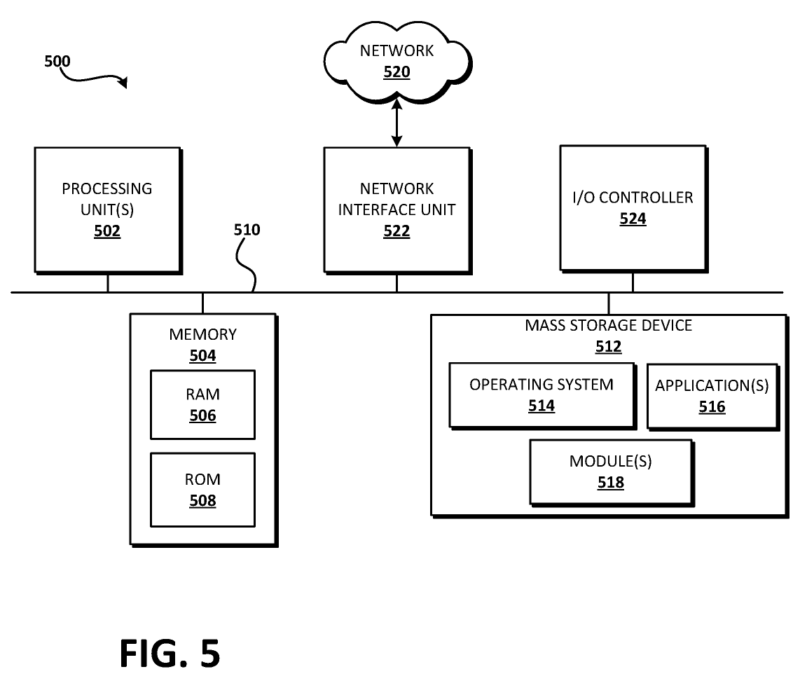

FIG. 5 shows additional details of an example computer architecture 500 for a device, such as a computer or a server configured as part of the systems described herein, capable of executing computer instructions (e.g., a module or a program component described herein). The computer architecture 500 illustrated in FIG. 5 includes processing unit(s) 502, a system memory 504, including a random-access memory 506 (“RAM”) and a read-only memory (“ROM”) 508, and a system bus 510 that couples the memory 504 to the processing unit(s) 502.

Processing unit(s), such as processing unit(s) 502, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing unit(s) 502 through a mass storage controller connected to the bus 510. The mass storage device 512 and its associated computer-readable media provide non-volatile storage for the computer architecture 500. Although the description of computer-readable media contained herein refers to a mass storage device, it should be appreciated by those skilled in the art that computer-readable media can be any available computer-readable storage media or communication media that can be accessed by the computer architecture 500.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

It should be appreciated that the software components described herein may, when loaded into the processing unit(s) 502 and executed, transform the processing unit(s) 502 and the overall computer architecture 500 from a general-purpose computing system into a special-purpose computing system customized to facilitate the functionality presented herein. The processing unit(s) 502 may be constructed from any number of transistors or other discrete circuit elements, which may individually or collectively assume any number of states. More specifically, the processing unit(s) 502 may operate as a finite-state machine, in response to executable instructions contained within the software modules disclosed herein. These computer-executable instructions may transform the processing unit(s) 502 by specifying how the processing unit(s) 502 transition between states, thereby transforming the transistors or other discrete hardware elements constituting the processing unit(s) 502.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term "image" also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term "computer vision model" encompasses multi-modal models such as one or more versions of CLIP (Contrastive Language-Image Pre-Training) and BLIP (Bootstrapping Language-Image Pre-Training). Note the term "computer vision model" also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The present disclosure is supplemented by the following example clauses:

Example 1: A method comprising: receiving a plurality of 3D representations of a subject taken over a plurality of points in time; obtaining a plurality of poses of the subject from the plurality of 3D representations; constructing a plurality of parameterized models of the subject with the plurality of poses; generating a plurality of text-based joint representations of the subject from joint coordinates received from the plurality of parameterized models; generating a model input that combines the plurality of text-based joint representations with a prompt context; providing the model input to a machine learning model; receiving, from the machine learning model, a description of a motion of the subject; and displaying the description of the motion of the subject with a rendering of one of the plurality of 3D representations of the subject.

Example 2: The method of Example 1, wherein at least one of the plurality of 3D representations is constructed from a set of images taken of the subject from different angles at a same time.

Example 3: The method of Example 1, wherein the subject comprises a medical patient and a remote observer of the medical patient comprises a medical professional.

Example 4: The method of Example 1, wherein obtaining the plurality of poses comprises computing a plurality of joint positions from one of the plurality of 3D representations.

Example 5: The method of Example 1, wherein one of the plurality of parameterized models represents locations and orientations of regions of the subject at one of the plurality of points in time.

Example 6: The method of Example 1, further comprising: pre-computing joint angles by performing a trigonometric operation on locations of joints and their adjacent joints; and adding the pre-computed joint angles to the prompt context.

Example 7: The method of Example 1, wherein the prompt context includes a joint format that defines a structure of the text-based joint representations.

Example 8: The method of Example 7, wherein the joint format includes a frame number and a list of joint names.

Example 9: A system comprising: a processing unit; and a non-transitory computer-readable storage medium having computer-executable instructions stored thereupon, which, when executed by the processing unit, cause the processing unit to: receive plurality of 3D representations of a subject taken over a plurality of points in time; obtain a plurality of poses of the subject from the plurality of 3D representations; construct a plurality of parameterized models of the subject with the plurality of poses; generate a plurality of text-based joint representations of the subject from joint coordinates received from the plurality of parameterized models; generate a model input that combines the plurality of text-based joint representations with a prompt context, wherein the prompt context includes an indication of a requested metric; provide the model input to a machine learning model; receive, from the machine learning model, a metric of the subject; and display the metric with a rendering of one of the plurality of 3D representations of the subject.

Example 10: The system of Example 9, wherein the computer-executable instructions further cause the processing unit to: computing the metric across multiple of the plurality of text-based joint representations.

Example 11: The system of Example 10, wherein the metric measures a smoothness of motion, a range of motion, or a speed of motion.

Example 12: The system of Example 10, wherein the metric is compared to a same metric computed from a second plurality of text-based joint representations of the subject taken before a procedure that affected the subject.

Example 13: The system of Example 9, wherein the metric is displayed at a location that is within a defined distance of a joint of the subject that the metric is associated with.

Example 14: The system of Example 9, wherein the subject comprises an athlete, and wherein the metric measures a sports-related attribute about the athlete.

Example 15: A non-transitory computer-readable storage medium having encoded thereon computer-readable instructions that when executed by a processing unit causes a system to: receive plurality of 3D representations of a subject taken over a plurality of points in time; obtain a plurality of poses of the subject from the plurality of 3D representations; construct a plurality of parameterized models of the subject with the plurality of poses; generate a plurality of text-based joint representations of the subject from joint coordinates received from the plurality of parameterized models; generate a model input that combines the plurality of text-based joint representations with a prompt context, wherein the prompt context includes an indication of a requested metric; provide the model input to a machine learning model; receive, from the machine learning model, a description of motion of the subject and a metric of the subject; and display the description of motion and the metric with a rendering of one of the plurality of 3D representations of the subject.

Example 16: The computer-readable storage medium of Example 15, wherein the prompt context includes a joint format that describes a structure of one of the plurality of text-based joint representations.

Example 17: The computer-readable storage medium of Example 16, wherein the joint format indicates how one of the plurality of text-based joint representations encodes a list of joints.

Example 18: The computer-readable storage medium of Example 16, wherein the joint format indicates how one of the plurality of text-based joint representations encodes a frame number.

Example 19: The computer-readable storage medium of Example 16, wherein the prompt context 300 includes a description of a requested metric, wherein the machine learning model identifies a metric that corresponds to the requested metric.

Example 20: The computer-readable storage medium of Example 15, wherein the instructions further cause the processing unit to: train a second machine learning model with the description of motion or the metric.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a plurality of 3D representations of a subject taken over a plurality of points in time;
obtaining a plurality of poses of the subject from the plurality of 3D representations;
constructing a plurality of parameterized models of the subject with the plurality of poses;
generating a plurality of text-based joint representations of the subject from joint coordinates received from the plurality of parameterized models;
generating a model input that combines the plurality of text-based joint representations with a prompt context;
providing the model input to a machine learning model;
receiving, from the machine learning model, a description of a motion of the subject; and
displaying the description of the motion of the subject with a rendering of one of the plurality of 3D representations of the subject.

2. The method of claim 1, wherein at least one of the plurality of 3D representations is constructed from a set of images taken of the subject from different angles at a same time.

3. The method of claim 1, wherein the subject comprises a medical patient and a remote observer of the medical patient comprises a medical professional.

4. The method of claim 1, wherein obtaining the plurality of poses comprises computing a plurality of joint positions from one of the plurality of 3D representations.

5. The method of claim 1, wherein one of the plurality of parameterized models represents locations and orientations of regions of the subject at one of the plurality of points in time.

6. The method of claim 1, further comprising:
pre-computing joint angles by performing a trigonometric operation on locations of joints and their adjacent joints; and
adding the pre-computed joint angles to the prompt context.

7. The method of claim 1, wherein the prompt context includes a joint format that defines a structure of the text-based joint representations.

8. The method of claim 7, wherein the joint format includes a frame number and a list of joint names.

9. A system comprising:
a processing unit; and
a non-transitory computer-readable storage medium having computer-executable instructions stored thereupon, which, when executed by the processing unit, cause the processing unit to:
receive plurality of 3D representations of a subject taken over a plurality of points in time;
obtain a plurality of poses of the subject from the plurality of 3D representations;
construct a plurality of parameterized models of the subject with the plurality of poses;
generate a plurality of text-based joint representations of the subject from joint coordinates received from the plurality of parameterized models;
generate a model input that combines the plurality of text-based joint representations with a prompt context, wherein the prompt context includes an indication of a requested metric;
provide the model input to a machine learning model;
receive, from the machine learning model, a metric of the subject; and
display the metric with a rendering of one of the plurality of 3D representations of the subject.

10. The system of claim 9, wherein the computer-executable instructions further cause the processing unit to:
computing the metric across multiple of the plurality of text-based joint representations.

11. The system of claim 10, wherein the metric measures a smoothness of motion, a range of motion, or a speed of motion.

12. The system of claim 10, wherein the metric is compared to a same metric computed from a second plurality of text-based joint representations of the subject taken before a procedure that affected the subject.

13. The system of claim 9, wherein the metric is displayed at a location that is within a defined distance of a joint of the subject that the metric is associated with.

14. The system of claim 9, wherein the subject comprises an athlete, and wherein the metric measures a sports-related attribute about the athlete.

15. A non-transitory computer-readable storage medium having encoded thereon computer-readable instructions that when executed by a processing unit causes a system to:
receive plurality of 3D representations of a subject taken over a plurality of points in time;
obtain a plurality of poses of the subject from the plurality of 3D representations;
construct a plurality of parameterized models of the subject with the plurality of poses;
generate a plurality of text-based joint representations of the subject from joint coordinates received from the plurality of parameterized models;
generate a model input that combines the plurality of text-based joint representations with a prompt context, wherein the prompt context includes an indication of a requested metric;
provide the model input to a machine learning model;
receive, from the machine learning model, a description of motion of the subject and a metric of the subject; and
display the description of motion and the metric with a rendering of one of the plurality of 3D representations of the subject.

16. The computer-readable storage medium of claim 15, wherein the prompt context includes a joint format that describes a structure of one of the plurality of text-based joint representations.

17. The computer-readable storage medium of claim 16, wherein the joint format indicates how one of the plurality of text-based joint representations encodes a list of joints.

18. The computer-readable storage medium of claim 16, wherein the joint format indicates how one of the plurality of text-based joint representations encodes a frame number.

19. The computer-readable storage medium of claim 16, wherein the prompt context 300 includes a description of a requested metric, wherein the machine learning model identifies a metric that corresponds to the requested metric.

20. The computer-readable storage medium of claim 15, wherein the instructions further cause the processing unit to:
train a second machine learning model with the description of motion or the metric.
